(19) United States
(12) Patent Application Publication
(10) Pub. No.: US 2023/0334309 A1
(43) Pub. Date: Oct. 19, 2023

(54) AUGMENTING ELECTRONIC DOCUMENTS TO GENERATE SYNTHETIC TRAINING DATA SETS

(71) Applicant: SAP SE, Walldorf (DE)

(72) Inventors: Alexey Streltsov, Heidelberg (DE); Monit Shah Singh, Leimen (DE); Dhananjay Tomar, Oslo (NO); Christian Reisswig, Oranienburg (DE); Minh Duc Bui, Mannheim (DE)

(21) Appl. No.: 17/720,658

(22) Filed: Apr. 14, 2022

(51) Int. Cl. G06N 3/08

(52) U.S. Cl. CPC G06N 3/08

(57) ABSTRACT

Systems, methods, and computer-readable media for generating a synthetic training data set from an original unstructured electronic document are disclosed. The synthetic training data set may be used to train a deep learning model to extract data from the original electronic document. The original electronic document may comprise annotated data fields. Each annotated data field may comprise a bounding box and a label. The original electronic document may comprise a header, a table, and a footer. Macro augmentation operations may be applied to the original electronic document to create sub-templates representative of distinct page layouts in the original electronic document. The synthetic training data set may be generated by applying geometric and semantic data augmentations to the sub-templates and the original electronic documents. The synthetic training data set may then be provided the deep learning model for training.

### BACKGROUND

### 1. Field

Embodiments of the present teachings relate to training learning models to extract data from an electronic document. Specifically, embodiments of the present teachings relate to augmenting electronic documents to generate synthetic electronic documents forming a training data set sufficient to a deep learning model to extract data from the electronic document.

### 2. Related Art

Many machine and deep learning models exist to extract data from electronic documents. For example, electronic invoices may have line item information extracted therefrom to automate the process of manually entering the line item information. Training such models requires a large volume of annotated training documents (e.g., invoices) that the learning models can be trained on. Typically, the training documents are human-annotated and require a large time and cost investment to annotate. Further, the learning model is often a global model that is trained on commonly-used electronic documents. When electronic documents differ structurally from the electronic documents the learning model was trained on, the learning model may fail to accurately extract data. When this occurs, it is typical to provide the learning model with annotations of the structurally-different electronic document, retrain the model, and change the logic of the learning model. However, this approach is time consuming due to the large number of annotated documents required for training. Further, such an approach does not guarantee an improvement in the model because adding additional training data generally leads to an average improvement of the model performance, while an improvement on extracting data from the structurally-different electronic document is not guaranteed. Further issues exist in traditional learning models that suffer from label imbalance such that the model is biased towards labels seen more often during training. Thus, the model may struggle to identify labels that are less often seen during the training phase.

What is needed are systems, programs, and methods for generating synthetic electronic documents for training learning models. Further still, what is needed are systems, programs, and methods for generating synthetic electronic documents from a single or a small set of electronic documents. Furthermore, what is needed are systems, programs, and methods for generating synthetic electronic documents to train a custom learning model on the layout of a specific electronic document layout.

### SUMMARY

Embodiments of the disclosure solve the above-described problems by providing programs, systems, and methods for generating synthetic electronic documents from an original electronic document for training learning models. The original electronic document may comprise a plurality of annotated data fields from which data may be extracted. Each annotated data field may comprise a bounding box and a label. To create synthetic electronic documents, macro and micro augmentation operations may be applied to the annotated data fields to create a synthetic electronic document comprising both semantic and structural variance from the original electronic document. The augmentations may be applied manually by the user to provide controllable creation of the synthetic electronic documents and/or applied automatically to generate a large training data set for training the model on a specific electronic document layout. The macro operations may be performed to generate sub-templates. Each sub-template may correspond to the layout of a page of a multi-page electronic document. The micro operations may comprise a combination of semantic and geometric augmentations. The semantic augmentations may comprise changing a string in the data field. For example, an address in the original electronic document may be changed to a random address in the synthetic electronic document. The geometric augmentations may comprise at least one of a shift, a clone, a swap, a delete, or a crop operation. By creating a training data set comprising synthetic electronic documents with a shared layout, the learning model may be better trained to accurately extract data from electronic documents having said shared layout.

In some aspects, the techniques described herein relate to one or more non-transitory computer-readable media storing computer-executable instructions that, when executed by at least one processor, perform a method of generating a synthetic training data set for training a deep learning model, the method including: receiving an original electronic document, the original electronic document including a plurality of annotated data fields; generating, based on the original electronic document, a plurality of sub-templates, wherein each sub-template of the plurality of sub-templates includes a distinct layout; generating a plurality of synthetic electronic documents by applying a plurality of data augmentations to the plurality of sub-templates and the original electronic document; and providing the plurality of synthetic electronic documents to the deep learning model for training.

In some aspects, the techniques described herein relate to a media, wherein a data augmentation of the plurality of data augmentations includes one or several combinations of shifts, clones, swaps, deletes, or crops.

In some aspects, the techniques described herein relate to a media, wherein the method further includes receiving, from a user, a rule for applying the plurality of data augmentations to the plurality of sub-templates, or the original electronic document.

In some aspects, the techniques described herein relate to a media, wherein the method further includes receiving, from a user, a rule for applying the plurality of data augmentations to at least one of the plurality of sub-templates or the original electronic document.

In some aspects, the techniques described herein relate to a media, wherein a data augmentation of the plurality of data augmentations includes a semantic data augmentation, and wherein the method further includes retrieving, from an electronic dictionary associated with an annotated data field of the plurality of annotated data fields, a string for the semantic data augmentation.

In some aspects, the techniques described herein relate to a media, wherein a sub-template of the plurality of sub-templates is generated by: identifying the header section and the footer section in the original electronic document; responsive to identifying, deleting the header section and the footer section; and shifting the table section in an arbitrary direction in the sub-template.

In some aspects, the techniques described herein relate to a media, wherein a sub-template of the plurality of sub-templates is generated by: identifying the header section and the table section in the original electronic document; responsive to identifying the header section and the table section, deleting the header section and the table section; and shifting the footer section by an arbitrary value and in an arbitrary direction of the sub-template.

In some aspects, the techniques described herein relate to a method of generating a synthetic training data set for training a deep learning model, the method including: receiving an original electronic document, the original electronic document including a plurality of annotated data fields; receiving, from a user, at least one data augmentation to apply to at least one annotated data field of the plurality of annotated data fields; responsive to receiving the at least one data augmentation, applying the at least one data augmentation to the original electronic document to create a synthetic electronic document; and providing the synthetic electronic document to the deep learning model for training.

In some aspects, the techniques described herein relate to a method, wherein the method further includes receiving, from the user, a first selection of a first bounding box of a first portion of the original electronic document; and receiving, from the user, a second selection of a second bounding box of a second portion of the original electronic document, wherein the at least one data augmentation is applied between the first bounding box and the second bounding box.

In some aspects, the techniques described herein relate to a method, wherein the at least one data augmentation includes at least one of a swap, a copy, or a move augmentation.

In some aspects, the techniques described herein relate to a method, wherein at least one of the first bounding box or the second bounding box includes at least a subset of the plurality of annotated data fields.

In some aspects, the techniques described herein relate to a method, wherein the first bounding box or the second bounding box includes no annotated data fields.

In some aspects, the techniques described herein relate to a method, wherein the method further includes receiving, from the user, a selection of a bounding box in the original electronic document, the bounding box including at least a subset of the plurality of annotated data fields, wherein the at least one data augmentation is applied to the subset of the plurality of annotated data fields.

In some aspects, the techniques described herein relate to a method, wherein the at least one data augmentation includes at least one of a shift, a clone, a delete, or a copy augmentation.

In some aspects, the techniques described herein relate to a system for generating a synthetic training data set for training a deep learning model, the system including: at least one processor; a datastore; and one or more non-transitory computer-readable media storing computer-executable instructions that, when executed by the at least one processor, perform a method for generating the synthetic training data set for training the deep learning model, the method including: receiving at least one original electronic document including a plurality of annotations, wherein each annotation of the plurality of annotations includes a bounding box and a label; generating, based on the at least one original electronic document, a first sub-template and a second sub-template; generating a plurality of synthetic electronic documents by applying a plurality of data augmentations to the first sub-template, the second sub-template, and the at least one original electronic document; and providing the plurality of synthetic electronic documents to the deep learning model for training.

In some aspects, the techniques described herein relate to a system, wherein the first sub-template includes a table page layout, and wherein the second sub-template includes a footer page layout.

In some aspects, the techniques described herein relate to a system, wherein the plurality of data augmentations includes a clone operation applied to each label in the table page layout.

In some aspects, the techniques described herein relate to a system, wherein the method further includes randomly cropping each of the plurality of synthetic electronic documents.

In some aspects, the techniques described herein relate to a system, wherein the method further includes receiving, from a user, a rule, the rule defining a data augmentation to apply to at least one of the first sub-template or the second sub-template.

In some aspects, the techniques described herein relate to a system, wherein the method further includes receiving, from a user, a creation of a new label; and responsive to receiving, remapping the label to the new label, wherein the plurality of data augmentations is applied to the new label.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1A depicts an example original electronic document for some embodiments;

FIG. 1B depicts an example synthetic electronic document generated from the example original electronic document for some embodiments;

FIG. 2 depicts an augmentation-area bounding box for applying bulk data augmentations to original electronic documents for some embodiments;

FIG. 3 depicts a flow diagram for the generation of a synthetic training data set for some embodiments;

FIG. 4 depicts an exemplary method for generating synthetic electronic documents for training a learning model for some embodiments; and

FIG. 5 depicts an exemplary embodiment of a hardware platform for use with embodiments of the present disclosure.

The drawing figures do not limit the present teachings to the specific embodiments disclosed and described herein. The drawings are not necessarily to scale, emphasis instead being placed upon clearly illustrating the principles of the present teachings.

### DETAILED DESCRIPTION

The following detailed description references the accompanying drawings that illustrate specific embodiments in which the present teachings can be practiced. The embodiments are intended to describe aspects of the present teachings in sufficient detail to enable those skilled in the art to practice the present teachings. Other embodiments can be utilized, and changes can be made without departing from the scope of the present teachings. The following detailed description is, therefore, not to be taken in a limiting sense. The scope of the present teachings is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments are generally directed towards generating a synthetic training data set for training a deep learning model to recognize and extract data from an unstructured electronic document. A single or a subset of original electronic documents may be received. The original electronic documents may comprise annotated data fields, with each annotated data field comprising a bounding box and a label. Various data augmentations may be applied to the original electronic documents to generate synthetic electronic documents having structural and/or syntactic variance from the original electronic documents. For example, a line item in the original electronic document may have the text changed and the line item may be shifted to the right (e.g., by 10 pixels). Portions of the entire electronic document may have similar augmentations applied to create a synthetic electronic document that is similar to the original electronic document, while having sufficient variation to effectively train the learning model. This process may then repeat until a sufficiently large set of synthetic electronic documents capable of training the deep learning model is generated.

In some embodiments, the electronic document comprises a header section, a table section, a footer section, or a combination thereof. The electronic document may be a multi-page electronic document. Each page in the multi-page electronic document may comprise a distinct layout. To produce synthetic electronic documents representing each page layout in the electronic document, sub-templates may be created from the electronic documents. For example, a sub-template may comprise a tabular layout, such as often seen on an electronic invoice with line item information. Similarly, a sub-template may comprise a last page layout for the electronic invoice, comprising the end of the table and a footer. The plurality of synthetic electronic documents may then be generated by performing further augmentations on the first sub-template, the second sub-template, and the original electronic document to create synthetic electronic documents that are representative of multi-page electronic documents.

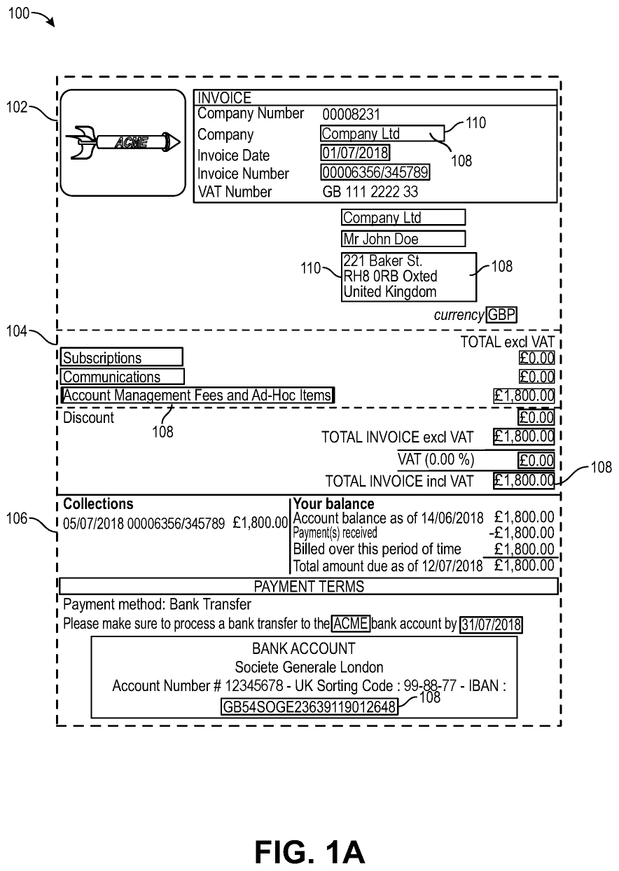

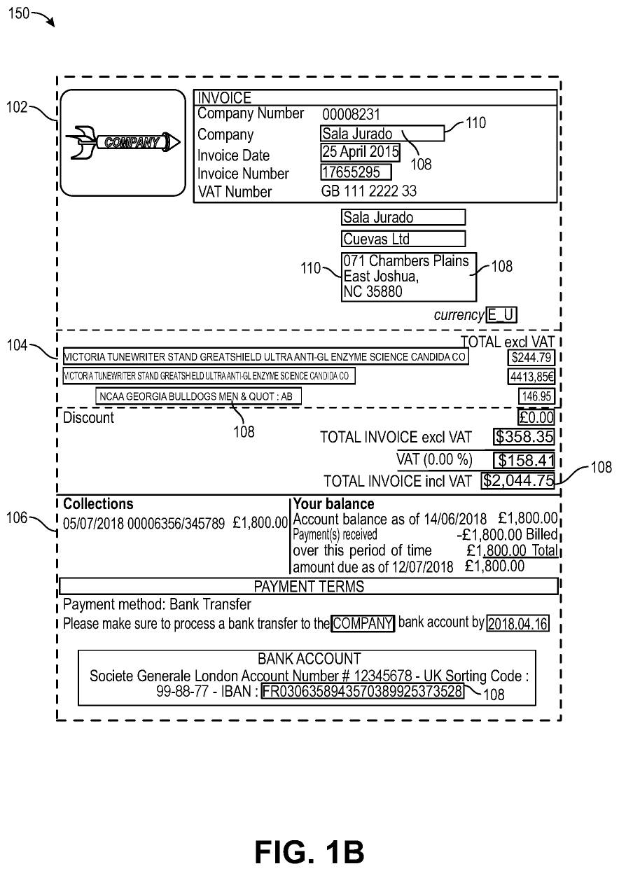

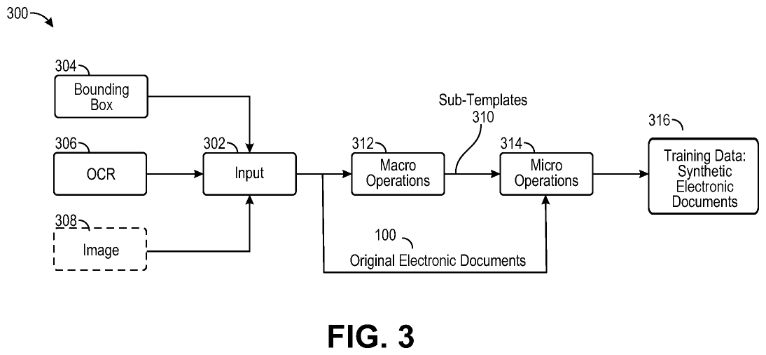

FIG. 1A illustrates an example of an original electronic document 100 for some embodiments. Original electronic document 100 may be an electronic document such as an invoice, a payment advice, a paycheck, a purchase order, a receipt, or any other electronic document. Original electronic document 100 may be an unstructured document (such as an image file in a PNG, PDF, BMP, or other like formats). As discussed below with respect to FIG. 3, input files for original electronic document 100 may comprise an annotation bounding box file, an optical character recognition (OCR) file for original electronic document 100, and an image file of original electronic document 100. Original electronic document 100 may be separated into various sections. The sections may vary depending on the type of electronic document. For example, the electronic invoice illustrated in FIG. 1A, comprises a header section 102, a table section 104, and a footer section 106. As another example, a payment advice may only have a header section 102 and a table section 104. In some embodiments, sections 102, 104, 106 are annotated by the user. Alternatively, or additionally, as discussed below, sections 102, 104, 106 may be automatically determined based on rules defined by the user. While three sections 102, 104, 106 are illustrated, original electronic document 100 may comprise fewer or more than three sections.

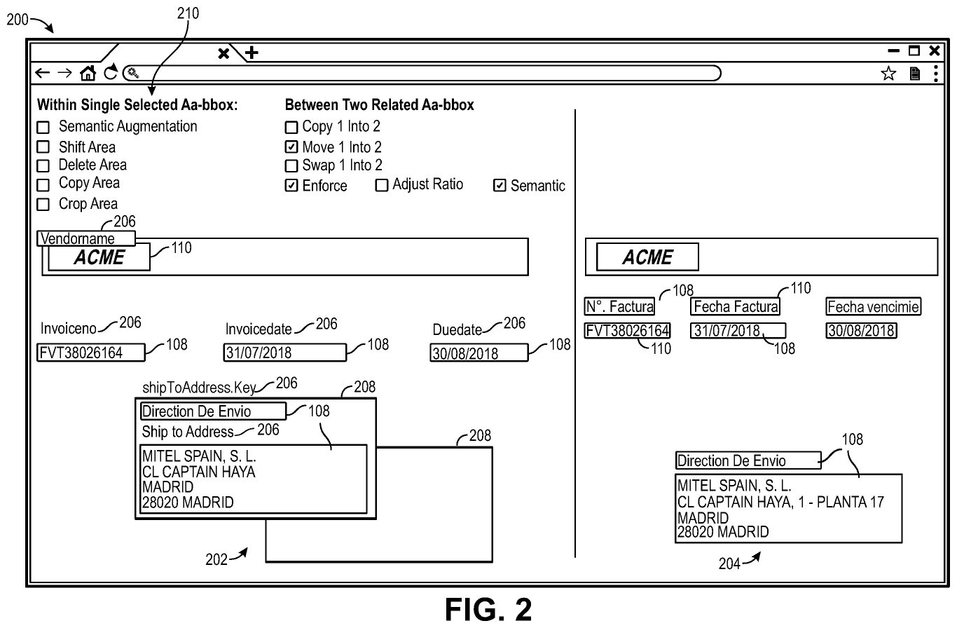

Original electronic document 100 may comprise a plurality of annotated data fields 108. Each section 102, 104, 106 may comprise annotated data fields 108. Each annotated data field 108 may comprise a bounding box 110 and an associated label (see FIG. 2). For example, the annotated data field 108 for an address field in header section 102 may comprise a label indicating that data within the respective bounding box 110 comprises address data. Similarly, a label may indicate data within a bounding box 110 is total invoice data. Each bounding box 110 may have coordinate data stored therefor (e.g., pixel positions of each corner of the bounding box 110). While rectangular bounding boxes 110 are depicted, any shape of bounding box 110 may be used in embodiments described herein. For example, the bounding boxes 110 may be created using a free-form bounding box tool.

In some embodiments, a bounding box 110 for one or more of sections 102, 104, 106 is automatically determined for original electronic document 100. For example, rules may be defined indicating which portions of original electronic document 100 correspond to which sections 102, 104, 106. For example, a header section 102 may be defined as the portion of original electronic document 100 existing above a first occurrence of an annotated data field 108 comprising a line item label, and a footer section 106 may be defined as the portion of original electronic document 100 below the last occurrence of an annotated data field 108 comprising the line item label. A table section 104 may then comprise all data existing between the first and last occurrences of the line item labels. The “above” and “below” an annotated data field 108 may be defined in pixel dimensions. For example, the header section 102 may begin at five pixels above the first occurrence of the line item label. Alternatively, or additionally, the user may define a bounding box 110 indicating the region for at least one of sections 102, 104, 106.

Looking now at FIG. 1B, a synthetic electronic document 150 is depicted for some embodiments. As shown, synthetic electronic document 150 comprises a substantially similar layout to original electronic document 100 but comprises both geometric and semantic augmentations applied to annotated data fields 108. Synthetic electronic document 150 may comprise sections 102, 104, 106 from original electronic document 100. However, the position of sections 102, 104, 106 may change from original electronic document 100 due to augmenting annotated data fields 108.

The geometric augmentations may comprise at least one of a shift operation, a clone operation, a swap operation, a delete operation, or a crop operation. In some embodiments, annotated data fields 108 may be associated or linked for applying augmentations thereto. For example, an annotated data field 108 for a line item may be associated with an annotated data field 108 comprising the monetary value for said line item. Thus, any geometric augmentation applied to the line item annotated data field 108 may be mirrored by the linked monetary value annotated data field 108.

A shift operation may comprise a positional shift of an annotated data field 108. The shift may be up, down, left, right, or any combination thereof. In some embodiments, a distance limit is defined for the shift operations such that shifted annotated data fields 108 may not be shifted outside of a specified region of synthetic electronic document 150. For example, a 10% maximum shift of annotated data field 108 may be defined. The distance limit may vary for each annotated data field 108 in original electronic document 100. In some embodiments, the distance limit is a pixel limit or a percentage limit based on the coordinates of bounding box 110.

The clone operation may comprise a duplication of the annotated data fields 108. In some embodiments, the duplicated annotated data field 108 is semantically augmented from the original annotated data field 108 such that the duplicated annotated data field 108 comprises a string unique from the original annotated data field 108. In some embodiments, the clone operation is only applied to annotated data fields 108 in a specific section 102, 104, 106. For example, only annotated data fields 108 in table section 104 may be cloned to increase the size of the table. Cloning data in header section 102 or footer section 106 may result in header section 102 or footer section 106 that is not representative of the layout of original electronic document 100. Training the deep learning model on such a synthetic electronic document 150 may provide little benefit in teaching the model to extract data from original electronic document 100. Thus, the applied data augmentation may be based in part on the section 102, 104, 106 of original electronic document 100.

The swap operation may comprise the swapping of two annotated data fields 108. In some embodiments, swapping is only permitted between annotated data fields 108 sharing the same or similar labels. In some embodiments, the swap operation may be applied on multiple annotated data fields 108. For example, the user may select four annotated data fields 108, and the selected annotated data fields 108 may be swapped in the order in which annotated data fields 108 were selected.

The delete operation may comprise the deletion of an annotated data field 108. Deletions may also occur between associated annotated data fields 108 such that a delete operation applied to an annotated data field 108 automatically deletes any annotated data fields 108 linked thereto. For example, applying a delete operation to an annotated data field 108 comprising a line item label may cause the deletion of an associated annotated data field 108 comprising the monetary data value for said line item label.

The crop operation may comprise cropping of synthetic electronic document 150. Synthetic electronic document 150 may be cropped in any direction (e.g., from the top, bottom, left, or right, or any combination thereof) and may be cropped in any percentage of the size of original electronic document 100. In some embodiments, the cropping is selected randomly. For example, synthetic electronic document 150 may be cropped by 10% from both the right and the top. Similarly, in some embodiments, annotated data fields 108 may be cropped.

As illustrated, semantic augmentations may also be applied to annotated data fields 108 to change the text thereof. In some embodiments, each annotated data field 108 that is geometrically augmented also has a semantic augmentation applied thereto. In some embodiments, semantic augmentations also structurally augment synthetic electronic document 150 by increasing or decreasing a number of lines of the text. For example, an address field may change from a three-line address to a five-line address. In some embodiments, the user may define an upper and/or lower limit on the number of lines that an annotated data field 108 may comprise. In some embodiments, the user may specify the alignment of the semantic augmentation such as left, right, center, top, or bottom of bounding box 110. In some embodiments the font and/or font size of the semantic augmentation may be specified. In some embodiments, the semantic augmentations are retrieved from a dictionary or other string data store. Each label for an annotated data field 108 may have an associated dictionary. Multiple labels may share the same dictionary. For example, a dictionary may store randomly generated addresses that can be used to replace address annotated data fields 108. As another example, a dictionary may store monetary values and any annotated data fields 108 comprising monetary data may be semantically augmented by pulling from the dictionary.

Looking now at FIG. 2, an interface 200 displaying a second example original electronic document 202 and corresponding synthetic electronic document 204 for performing manual data augmentations is illustrated for some embodiments. Also depicted in FIG. 2 are labels 206 for annotated data fields 108. As described above, labels 206 may identify the data stored within a bounding box 110. For example, labels 206 define that the data within bounding boxes 110 correspond to invoice number, invoice date, vendor name, and the like. To annotate original electronic document 202, the user may draw bounding boxes 110 around data within original electronic document 202 and select or define a label 206 that corresponds to the data. Thereafter, the above-described geometric and semantic augmentations may be applied to original electronic document 202 to form synthetic electronic document 204. The manual augmentations may be performed using open-source data annotation tools such as Label Studio, for example.

In some embodiments, a user may create augmentation-area bounding boxes 208 for performing bulk data augmentations to multiple annotated data fields 108. Augmentation-area bounding boxes 208 may be drawn by the user to select a plurality of annotated data fields 108 for which data augmentations are to be collectively applied. For example, as shown, an address data field and a name data field have been selected in original electronic document 202 and are contained within augmentation-area bounding box 208. After selecting the augmentation-area bounding box 208, the user may input one or more data augmentations to apply thereto. In some embodiments, the user can select one or more of the above-described shift, delete, clone, crop, swap, or semantic augmentations to apply to augmentation-area bounding box 208. In some embodiments, an augmentation selection interface 210 is provided in interface 200 for selecting augmentations to apply to annotated data fields 108. In some embodiments, the selection of an augmentation prevents the selection of conflicting augmentations. For example, selecting the delete augmentation may prevent the user from selecting any further augmentations.

In some embodiments, the user can apply bulk data augmentations between two augmentation-area bounding boxes 208. In some embodiments, the user may select a first augmented-area bounding box 208 with multiple annotated data fields 108, and a second augmentation-area bounding box 208 comprising an area of original electronic document 100 containing no annotated data fields 108 (e.g., white space on interface 200). In some embodiments, each augmentation-area bounding box 208 comprises multiple annotated data fields 108. Once the two augmentation-area bounding boxes 208 are selected, the user may perform at least one of a copy operation, a shift operation, a swap operation, or any combination thereof on the augmentation-area bounding boxes 208. For example, as shown in synthetic electronic document 204, the first augmentation-area bounding box 208 was shifted into the area occupied by the second augmentation-area bounding box 208. As another example, the content of two augmentation-area bounding boxes 208 may be swapped. In some embodiments, augmentations are only permitted between augmentation-area bounding boxes 208 that comprise annotated data fields 108 sharing at least one label 206. In some embodiments, augmentations are only permitted between augmentation-area bounding boxes 208 that comprise annotated data fields 108 with the same label 206.

In some embodiments, the user may define rules for automatically augmenting original electronic documents 100 to create a plurality of synthetic electronic documents 150. For example, the user may specify a rule to shift text within an address field and to replace the address with a random address retrieved from the dictionary. This rule may then be repeatedly applied to create a plurality of synthetic electronic documents 150. In some embodiments, randomness is introduced into the created rules such that, for example, the amount of shift in the address field is randomly applied and, for each new synthetic electronic document 150 a random address is used. Thus, while the same augmentation operations are applied to the vendor address field, the augmentation values (e.g., shift distance, etc.) may be varied to effectively train the deep learning model. The randomness of the geometric augmentations may be controlled by the user (e.g., by setting upper and lower limits on the shift distance) to ensure the layout of synthetic electronic document 204 is substantially similar to that of original electronic document 202 while having variance to challenge the deep learning model during training. As another example, a rule may be defined to clone a random number of line items in a table section 104 to create a plurality of synthetic electronic document 150 with various-sized tables for training the model. For example, the user may set parameters for the rule such that the random number has a lower bound of 5 clones and an upper bound of 50 clones. Similarly, additional rules may be defined to apply semantic and geometric augmentations (e.g., shifts, semantic augmentations) to the cloned line items to add further variance to the synthetic electronic documents 150.

Manual data augmentations may allow users to assess the performance of the deep learning model by modifying annotated data fields 108 in a controllable and predictable manner. Thus, the user may easily assess how the model is learning on a specific label (e.g., an address label) of original electronic document 202 by generating a training data set with only semantic and geometric augmentations applied to the address field and retraining the model on said training data set. Thus, the sensitivity of the deep learning model to specific geometric and semantic augmentations made to a label may be learned.

Similarly, the label imbalance issue often faced by learning models may be alleviated with embodiments described herein. As one example, in the context of electronic invoices, a global learning model accurately extract data from a vendor's address field but may have poor performance when extracting data from a subtotal amount field because of the relative scarcity of this label in the global training data set. Thus, by supplying the learning model with a custom training data set comprising synthetic electronic documents 150 having the subtotal amount field, a custom learning model may be trained to accurately extract data from the subtotal amount field.

FIG. 3 illustrates a system 300 for carrying out embodiments of the present teachings. System 300 generally depicts the creation of a plurality of synthetic electronic documents 150 for training a learning model as described in embodiments herein. As described above, input files 302 for original electronic document 100 may be received for creating synthetic electronic documents 150 therefrom. In some embodiments, a set of original electronics documents 100 is received. Each original electronic document 100 may share the same layout and comprise a plurality of annotated data fields 108. Each original electronic document 100 in the set of original electronic document 100 may have different fields annotated. For example, a first original electronic document 100 may have more line items in a table section 104 annotated than a second original electronic document 100.

In some embodiments, input files 302 for original electronic document 100 comprise a bounding box file 304, an OCR file 306, an image file 308. The bounding box file 304 may be a plaintext file, or any other file type, comprising the coordinates of bounding boxes 110 for each annotated data field 108 in original electronic document 100. The bounding box file 304 may also comprise the label 206 associated with the bounding box 110. As described above, annotated data fields 108 may be generated by a human annotator. In some embodiments, annotated data fields 108 are automatically generated, and a human annotator may review and correct (if needed) the bounding boxes 110 and/or labels 206. The OCR file 306 may be generated by an OCR model and may be in the form of a JSON file, a CSV file, or the like. In some embodiments, a digital image file 308 of the original electronic document 100 is provided as input. The digital image file 308 may be a PNG, a JPEG, a JPG, a TIFF, or the like. The digital image file 308 may be referenced by the user when generating the training data set for visual inspection to ensure synthetic electronic documents 150 are accurately generated.

In some embodiments, electronic documents may span multiple pages. For example, instead of original electronic document 100 comprising a header, a table, and a footer on a single page, the table in original electronic document 100 may span three pages, and a last page for original electronic document 100 may comprise the end of table section 104 and footer section 106. If the original electronic document 100 received for generating synthetic electronic document 150 comprises only a single page layout, when the deep learning model attempts to extract data from an original electronic document 100 with multiple pages, the deep learning model may make errors because of the differences in layouts between pages of original electronic document 100. As described above, because of the significant investment required to annotate electronic documents, it is unlikely that a sufficient number of annotated original electronic documents 100 comprising multiple pages will be available for training the deep learning model. Thus, creation of synthetic electronic documents 150 allows for training custom learning models to extract data from a specific layout of original electronic document 100. To create synthetic electronic documents 150 that represent the layouts of the different pages in original electronic document 100, sub-templates 310 may be created. In some embodiments, a sub-template 310 is created for each unique page layout in original electronic document 100.

To create sub-templates 310, macro operations 312 may be applied to original electronic document 100. Macro operations 312 may comprise a set of rules for augmenting original electronic document 100. Users may define custom macro operations 312 to apply to original electronic document 100. For example, it may be desired to only train the deep learning model on only one section 102, 104, 106 (e.g., table section 104) of original electronic document 100. Thus, a macro operation 312 may be defined to delete the header section 102 and footer section 106 to create a sub-template 310 that only has the table section 104. Thereafter, synthetic electronic documents 150 may be created by applying augmentations to only the sub-template 310 that comprises table section 104.

In some embodiments, to represent a multi-page original electronic document 100 from a single page original electronic document 100, a first sub-template 310 and a second sub-template 310 are created. The first sub-template 310 may correspond to a middle page of the multi-page original electronic document 100, and the second sub-template 310 may correspond to a last page of the multi-page original electronic document 100. The first sub-template 310 may comprise only a table section 104. Creation of the first sub-template 310 may comprise identifying and applying a delete operation to header section 102 and footer section 106 in original electronic document 100, followed by applying a shift operation to table section 104 to move table section 104 near a top of the page. The second sub-template 310 may comprise footer section 106. Creation of the second sub-template may comprise identifying header section 102 and table section 104 and applying a delete operation thereto. A shift operation may then be applied to footer section 106 to move footer section 106 near a top of the page. In some embodiments, the second sub-template 310 comprises an end of table section 104 located above footer section 106. Thus, by performing further geometric and semantic augmentations to original electronic document 100, the first sub-template 310, and the second sub-template 310, synthetic electronic documents 150 for each page in a multi-page original electronic document 100 may be created.

Macro operations 312 are not limited to creation of sub-templates 310, and rules may be defined for macro operations 312 for applying various augmentations to original electronic document 100. In some embodiments, macro operations 312 comprises line item permutations to create a more diverse table section 104. Table section 104 may be permuted using the above-described geometric and semantic augmentations. Still further, macro operations 312 may comprise crop macro operations 312 applied to the generated synthetic electronic document 150. Macro operations 312 may be applied randomly to increase the diversity of the training data set. In some embodiments, the user may define an order in which macro operations 312 are applied to original electronic document 100. For example, the user may define that macro operations 312 for creation of sub-templates 310 are to be applied to original electronic document 100 prior to applying macro operations 312 for cropping both original electronic document 100 and sub-templates 310.

After applying macro operations 312, micro operations 314 may be applied to the sub-templates 310 and/or original electronic document 100 to create a plurality of synthetic electronic documents 150 for training data set 316. In some embodiments, micro operations 314 may be applied before macro operations 312. Micro operations 314 may comprise applying shift operations to all labels 206. In some embodiments, the shift operations comprise a substantially small percent shift. For example, a label 206 may be shifted by 2% downwards by modifying the coordinates of bounding box 110. In some embodiments, micro operations 314 comprises applying a shift operation to all annotated data fields 108 in original electronic document 100 and sub-templates 310. Micro operations 314 may also comprise clone operations on labels 206. In some embodiments, only specified labels 206 are cloned, such as those associated with line items in table section 104. Thus, the size of the table may be inflated to approximate a multi-page electronic document. As previously described, cloning information in the header section 102 and/or footer section 106 may result in a synthetic electronic document 150 that is too dissimilar from the layout of original electronic document 100 to be useful in training the learning model to recognize and extract data. In some embodiments, micro operations 314 comprise cloning line items such that each table in training data set 316 has a unique table size. In some such embodiments, these clone operations may replace the values in cloned line items with unique data to reflect actual documents more accurately.

In some embodiments, micro operations 314 may comprise semantic augmentations to text in labels 206. In some embodiments, each annotated data field 108 is semantically augmented. When applying semantic augmentations, bounding boxes 110 may be modified to account for the new text. For example, if the semantic augmentation adds two new text lines, the size of bounding box 110 may be increased accordingly. In some embodiments, the semantic augmentations are performed after geometric augmentations. In some embodiments, the semantic augmentations are performed prior to the geometric augmentations. Thus, by applying micro operations 314, a synthetic electronic document 150 may be obtained comprising the same layout as original electronic document 100 with various geometric and semantic differences that allow the learning model to be trained effectively thereon. As described above, a generic learning model may struggle to properly extract data from an original electronic document 100 having a layout distinct from the layout of the training data the model was trained on. Thus, by creating a training data set 316 comprising synthetic documents with the same layout as original electronic document 100, a learning model can effectively be trained on a specific layout type without incurring the disadvantages of collecting and manually annotating a large training data set.

As described above, micro operations 314 may be applied to both original electronic document 100 and sub-templates 310 created from macro operations 312. For example, the original electronic document 100 may be a one page invoice as illustrated in FIG. 1A. Thus, to create a large training data set, micro operations 314 may be applied to original electronic document 100 to create a plurality of one page synthetic electronic documents 150 and to the sub-templates 310 to create a plurality of middle page synthetic electronic documents 150 and last page synthetic electronic documents 150. Thus, each page in a multi-page original electronic document 100 may be present in training data set 316. In some embodiments, a user can specify a percentage or number of single-page synthetic electronic documents 150, middle, and last page synthetic electronic documents 150 to create for training data set 316. For example, based on prior knowledge of the specific original electronic document 100, the user may elect to have the training data set 316 comprise 60% of single page synthetic electronic documents 150 and 20% each of middle and last page synthetic electronic documents 150. In some embodiments, the micro operations 314 are randomly generated to reduce the likelihood that identical synthetic electronic documents 150 are created.

In some embodiments, system 300 is customizable by the user. For example, the order of macro operations 312 and/or micro operations 314 may be adjusted. Similarly, in some embodiments, macro operations 312 and/or micro operations 314 may be omitted entirely. Further, as described above, the user may define their own macro operations 312.

In some embodiments, the user can remap existing labels 206 to new labels 206. For example, if original electronic document 100 is received comprising a label 206 for a vendor address annotated data fields 108, the user may remap the vendor address label 206 to a label 206 called myAddress. When generating synthetic documents 150, data augmentations that were to be applied to the vendor address label 206 may then be applied to the myAddress label.

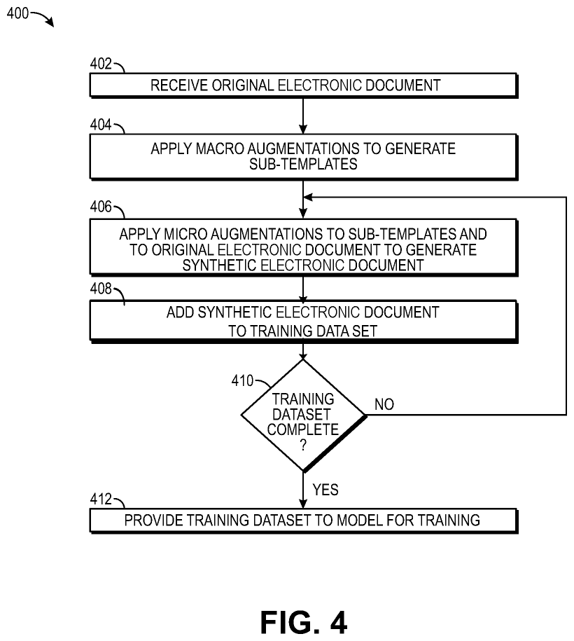

FIG. 4 illustrates an exemplary method 400 for generating a synthetic training data set 316 for training a deep learning model for some embodiments. At step 402, one or more original electronic documents 100 may be received. Original electronic document 100 may be any type of electronic document, such as an invoice, a payment receipt, or any other annotated original electronic document 100. Original electronic document 100 may be an unstructured document. In some embodiments, input files 302 for the original electronic document 100 comprises a bounding box file 304, an OCR file 306, a digital image file 308. The original electronic document 100 may comprise a plurality of annotated data fields 108.

Next, at step 404, macro operations 312 may be applied to original electronic document 100 to generate sub-templates 310. As described above, each sub-template 310 may correspond to a page layout of a multipage original electronic document 100. Further, the macro operations 312 may comprise line item permutations for a table section 104. Still further, crop macro operations 312 may be randomly applied to original electronic document 100 and/or to sub-templates 310 to generate cropped synthetic electronic documents 150. Macro operations 312, such as crop macro operations 312 and permutation macro operations 312, may also be applied to sub-templates 310.

Thereafter, at step 406, micro operations 314 may be applied to generate a plurality of synthetic electronic documents 150. Micro operations 314 may be applied to each of original electronic document 100 and sub-templates 310 to generate synthetic electronic documents 150 with geometric and syntactic variety. Micro operations 314 may comprise the above-described geometric and semantic augmentations to generate diverse data fields for training the learning model. In some embodiments, a label 206 is associated with a dictionary from which semantic augmentations may be retrieved. For example, a date label 206 may have an associated date dictionary which may comprise dates in various formats to train the learning model on. Thus, the date label 206 may change from the European date format (i.e., 1 Jan. 2022) to the American date format (i.e., Jan. 1, 2022) such that the learning model can recognize a variety of syntaxes. In some embodiments, users may import custom dictionaries for retrieving semantic augmentations. Thus, the user may customize the generation of the synthetic training data set to include different languages, currencies, measurement systems, and the like.

At step 408, the synthetic electronic document 150 may be added to the training data set 316. Thereafter, at test 410, it may be determined whether the training data set 316 is complete. If the training data set 316 is complete, processing may proceed to step 412, and the training data set 316 may be provided to the learning model for training thereon. If the training data set 316 is not complete, processing may proceed back to step 406 for generation of an additional synthetic electronic document 150. In some embodiments, the size of the training data set 316 is preset by the user.

It should be noted that while embodiments have been described herein with respect to an original electronic document 100 having a header section 102, a table section 104, and a footer section 106, such a layout of original electronic document 100 is not meant to be limiting. Any original electronic document 100 comprising annotated data fields 108 may be in conjunction with embodiments described herein. Based on the layout of original electronic document 100, the user may define various sections therefor along with sub-templates 310 to create various 312 for training the deep learning model thereon.

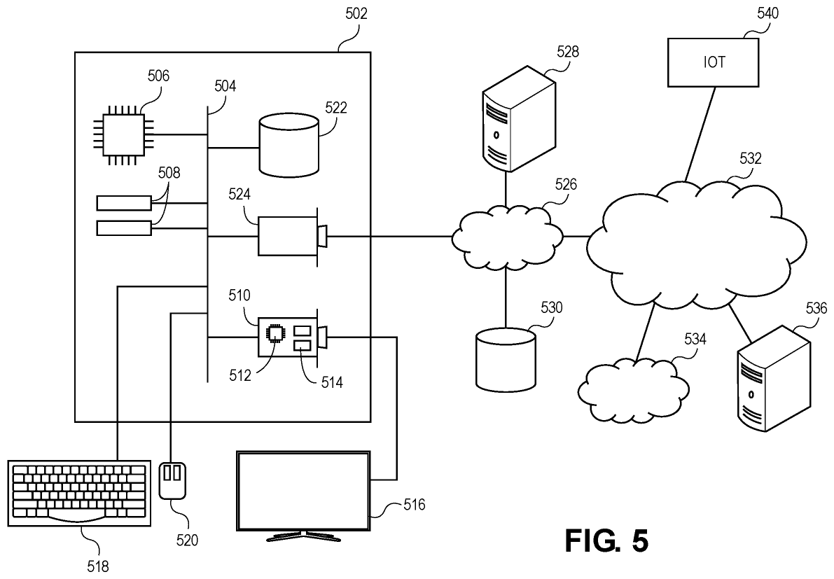

Turning to FIG. 5, an exemplary hardware platform that can form one element of certain embodiments of the disclosure is depicted. Computer 502 can be a desktop computer, a laptop computer, a server computer, or any other form factor of general- or special-purpose computing device. Depicted with computer 502 are several components, for illustrative purposes. In some embodiments, certain components may be arranged differently or absent. Additional components may also be present. Included in computer 502 is system bus 504, whereby other components of computer 502 can communicate with each other. In certain embodiments, there may be multiple buses or components may communicate with each other directly. Connected to system bus 504 is central processing unit (CPU) 506. Also attached to system bus 504 are one or more random-access memory (RAM) modules 508. Also attached to system bus 504 is graphics card 510. In some embodiments, graphics card 510 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media and may be internally installed in computer 502 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 524 is also attached to system bus 504 and allows computer 502 to communicate over a network such as local network 526. NIC 524 can be any form of network interface known in the art, such as Ethernet, ATM, fiber, BLUETOOTH, or Wi-Fi (i.e., the IEEE 802.11 family of standards). NIC 524 connects computer 502 to local network 526, which may also include one or more other computers, such as computer 528, and network storage, such as data store 530. Generally, a data store such as data store 530 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 528, accessible on a local network such as local network 526, or remotely accessible over Internet 532. Local network 526 is in turn connected to Internet 532, which connects many networks such as local network 526, remote network 534 or directly attached computers such as computer 536. In some embodiments, computer 502 can itself be directly connected to Internet 532. In some embodiments, Internet 532 connects to one or more Internet of Things (IoT) devices 540.

Although the disclosure has been described with reference to the embodiments illustrated in the attached drawing figures, it is noted that equivalents may be employed, and substitutions made herein without departing from the scope of the disclosure as recited in the claims.

Having thus described various embodiments of the disclosure, what is claimed as new and desired to be protected by Letters Patent includes the following:

1. One or more non-transitory computer-readable media storing computer-executable instructions that, when executed by at least one processor, perform a method of generating a synthetic training data set for training a deep learning model, the method comprising:
receiving an original electronic document, the original electronic document comprising a plurality of annotated data fields;
generating, based on the original electronic document, a plurality of sub-templates,
wherein each sub-template of the plurality of sub-templates comprises a distinct layout;
generating a plurality of synthetic electronic documents by applying a plurality of data augmentations to the plurality of sub-templates and the original electronic document; and
providing the plurality of synthetic electronic documents to the deep learning model for training.

2. The media of claim 1, wherein a data augmentation of the plurality of data augmentations comprises at least one of a shift, a clone, a swap, a delete, or a crop.

3. The media of claim 1, wherein the method further comprises receiving, from a user, a rule for applying the plurality of data augmentations to the plurality of sub-templates, or the original electronic document.

4. The media of claim 1,
wherein a data augmentation of the plurality of data augmentations comprises a semantic data augmentation, and
wherein the method further comprises retrieving, from an electronic dictionary associated with an annotated data field of the plurality of annotated data fields, a string for the semantic data augmentation.

5. The media of claim 1, wherein the method further comprises:
identifying a header section, a table section, and a footer section of the original electronic document,
wherein a data augmentation of the plurality of data augmentations is selected based in part on a section of the original electronic document.

6. The media of claim 5, wherein a sub-template of the plurality of sub-templates is generated by:
identifying the header section and the footer section in the original electronic document;
responsive to identifying, deleting the header section and the footer section; and
shifting the table section in an arbitrary direction in the sub-template.

7. The media of claim 5, wherein a sub-template of the plurality of sub-templates is generated by:
identifying the header section and the table section in the original electronic document;
responsive to identifying the header section and the table section, deleting the header section and the table section; and
shifting the footer section by an arbitrary value and in an arbitrary direction of the sub-template.

8. A method of generating a synthetic training data set for training a deep learning model, the method comprising:
receiving an original electronic document, the original electronic document comprising a plurality of annotated data fields;
receiving, from a user, at least one data augmentation to apply to at least one annotated data field of the plurality of annotated data fields;
responsive to receiving the at least one data augmentation, applying the at least one data augmentation to the original electronic document to create a synthetic electronic document; and
providing the synthetic electronic document to the deep learning model for training.

9. The method of claim 8, wherein the method further comprises:
receiving, from the user, a first selection of a first bounding box of a first portion of the original electronic document; and
receiving, from the user, a second selection of a second bounding box of a second portion of the original electronic document,
wherein the at least one data augmentation is applied between the first bounding box and the second bounding box.

10. The method of claim 9, wherein the at least one data augmentation comprises at least one of a swap, a copy, or a move augmentation.

11. The method of claim 9, wherein at least one of the first bounding box or the second bounding box comprises at least a subset of the plurality of annotated data fields.

12. The method of claim 9, wherein the first bounding box or the second bounding box comprises no annotated data fields.

13. The method of claim 8, wherein the method further comprises:
receiving, from the user, a selection of a bounding box in the original electronic document, the bounding box comprising at least a subset of the plurality of annotated data fields,
wherein the at least one data augmentation is applied to the subset of the plurality of annotated data fields.

14. The method of claim 13, wherein the at least one data augmentation comprises at least one of a shift, a clone, a delete, or a copy augmentation.

15. A system for generating a synthetic training data set for training a deep learning model, the system comprising:
at least one processor;
a datastore; and
one or more non-transitory computer-readable media storing computer-executable instructions that, when executed by the at least one processor, perform a method for generating the synthetic training data set for training the deep learning model, the method comprising:
receiving at least one original electronic document comprising a plurality of annotations,
wherein each annotation of the plurality of annotations comprises a bounding box and a label;
generating, based on the at least one original electronic document, a first sub-template and a second sub-template;
generating a plurality of synthetic electronic documents by applying a plurality of data augmentations to the first sub-template, the second sub-template, and the at least one original electronic document; and
providing the plurality of synthetic electronic documents to the deep learning model for training.

16. The system of claim 15,
wherein the first sub-template comprises a table page layout, and
wherein the second sub-template comprises a footer page layout.

17. The system of claim 16, wherein the plurality of data augmentations comprises a clone operation applied to each label in the table page layout.

18. The system of claim 15, wherein the method further comprises randomly cropping each of the plurality of synthetic electronic documents.

19. The system of claim 15, wherein the method further comprises receiving, from a user, a rule, the rule defining a data augmentation to apply to at least one of the first sub-template or the second sub-template.

20. The system of claim 15, wherein the method further comprises:
receiving, from a user, a creation of a new label; and
responsive to receiving, remapping the label to the new label,
wherein the plurality of data augmentations is applied to the new label.
